(19) United States
(12) Patent Application Publication
(10) Pub. No.: US 2025/0140887 A1
(43) Pub. Date: May 1, 2025

(54) ELECTRODE-STACKING WHEEL HAVING AN ELECTRODE-CLAMPING ELEMENT, CORRESPONDING ELECTRODE-STACKING DEVICE, AND METHOD FOR PRODUCING AN ELECTRODE STACK

(71) Applicant: GIESECKE+DEVRIENT CURRENCY TECHNOLOGY GMBH, Munchen (DE)

(72) Inventors: Xaver THUM, Wolfratshausen (DE); Frank NEUDEL, Freising (DE)

(21) Appl. No.: 18/554,055

(22) PCT Filed: Apr. 1, 2022
(86) PCT No.: PCT/EP2022/025128

§ 371 Date: Oct. 5, 2023

(30) Foreign Application Priority Data
Apr. 8, 2021 (DE) 10 2021 001 819.2

(51) Int. Cl. H01M 10/04

(52) U.S. Cl. CPC H01M 10/0404

(57) ABSTRACT

An electrode-stacking wheel designed to receive and convey planar electrode elements, includes: a spindle designed for the rotating of the electrode-stacking wheel; a plurality of stacking fingers, which are radial to the spindle and which are arranged circumferentially around the axis of rotation; a plurality of intermediate spaces, which are formed between the respective stacking fingers, each intermediate space being designed to receive at least one of the electrode elements; and an electrode-clamping element formed in each of the intermediate spaces, each electrode-clamping element being designed such that, in the clamping state, the electrode-clamping element applies clamping force to a main surface of one of the electrode elements and presses the electrode element in question against the stacking finger in question by means of the force application.

The invention relates to an electrode-stacking wheel designed to receive and convey planar electrode elements. The electrode stacking wheel has a spindle which is designed to rotate the electrode stacking wheel. Furthermore, the electrode stacking wheel has a plurality of stacking fingers, which are radial to the spindle and which are arranged circumferentially around the spindle. Furthermore, the electrode stacking wheel has a plurality of intermediate spaces, each of which is formed between the respective stacking fingers, wherein a respective intermediate space is designed to receive at least one of the electrode elements. The invention also relates to a corresponding electrode stacking device and method for producing an electrode stack.

The stacking of planar electrode elements is known. Electrode elements for producing electrochemical energy stores, such as lithium-ion batteries or energy converters, such as fuel cells, are therefore usually stacked. Electrode elements are stacked to produce pouch cells in particular, a widely used design of a lithium-ion rechargeable battery.

The electrode elements are usually designed as a cathode, based, for example, on aluminum foil, and/or as an anode, based, for example, on copper foil. The smallest unit of each lithium-ion cell consists of two electrodes and at least one separator that separates the electrodes from one another. The ion-conductive electrolyte is subsequently placed between the two electrodes after filling.

During the stacking process, the electrode elements are stacked in a repeating cycle of anode, separator, cathode, separator, and so on and so forth.

In addition to the remaining steps in the production of electrochemical energy stores or fuel cells, such as assembly or contacting, for example, the step of stacking is often the bottleneck in the manufacturing throughput during production. There is therefore great interest in speeding up the stacking process.

Known methods for stacking the electrode elements are based on a gripping arm of a robot which grips and positions the electrode element. According to previous knowledge, however, no further significant speed increase is to be expected here.

Further known methods employ a rotating stacking wheel for stack formation, with which wheel the electrode elements are deposited on an electrode stack.

To this end, WO 2020/212316 A1 describes a method for producing an electrode stack of anodes and cathodes for a lithium-ion battery of an electrically driven motor vehicle, in which the anodes and the cathodes are conveyed into receptacles of a rotationally driven or rotationally drivable stacking wheel, and the anodes and cathodes received in the receptacles are conveyed to a stacking compartment by means of a rotation of the stacking wheel.

An important step when stacking the electrode elements with the aid of a stacking wheel is the accuracy with which the electrode elements are transported by the stacking wheel. The transporting accuracy has a direct effect on the stacking accuracy. In simplified terms, the more accurately the stacking wheel transports the electrode elements, the more accurately the electrode stack can be produced.

The object of the invention is to provide an electrode stacking wheel, an electrode stacking device, and a method for producing an electrode stack, with which or in which an electrode element can be stacked more accurately.

This object is achieved according to the invention by an electrode stacking wheel, an electrode stacking device, and a method with the features according to the respective independent claims. Advantageous embodiments of the invention are the subject matter of the dependent claims.

An electrode stacking wheel according to the invention is designed to receive and convey planar electrode elements. The electrode stacking wheel comprises the following:
a spindle designed to rotate the electrode stacking wheel;
a plurality of stacking fingers, which are radial to the spindle and which are arranged circumferentially around the spindle; and
a plurality of intermediate spaces, each of which is formed between the stacking fingers, wherein a respective intermediate space is designed to receive or be able to receive at least one of the electrode elements.

A key idea behind the invention can be seen in the fact that the electrode stacking wheel comprises an electrode clamping element which is formed in the intermediate spaces in each case. The electrode clamping element is designed, in the clamping state, to apply clamping force to a main surface of one of the electrode elements and to press the respective electrode element against the respective stacking finger by means of the application of force.

The invention is based on the knowledge that the accuracy of transporting can be increased by transporting the electrode elements from the electrode stacking wheel in the clamped state. As a result, it is possible to prevent the electrode elements from moving within the electrode stacking wheel and consequently being deposited inaccurately on the electrode stack.

The respective electrode clamping element can have two different states: A clamping state which is present when an electrode element is arranged in the intermediate space and the electrode clamping element exerts the clamping force on the electrode element. And a non-clamped state which is present when the intermediate space is vacant, in other words no electrode element is arranged in this space. In the non-clamped state, the electrode clamping element can be tension-free or relaxed.

In particular, the electrode stacking wheel has a plurality of stacking fingers. An intermediate space is preferably formed between each of the stacking fingers. At least one of the electrode clamping elements is preferably formed in the respective intermediate space. To keep descriptions simpler, the electrode clamping elements, the stacking fingers or the intermediate spaces are occasionally described below by means of just one respective example.

The stacking fingers are preferably elongate in each case. Furthermore, each stacking finger preferably tapers as the distance from the spindle increases.

The electrode clamping element is preferably elongate and/or finger-shaped. In particular, the electrode clamping element is tapered flat at the free end, in other words the end facing away from a contact point with the stacking finger.

Furthermore, the electrode clamping element is preferably designed to be bendable at least in the region of the contact point when force is applied, in particular the electrode clamping element moves back into the starting position when the application of force ceases. As a result, the electrode clamping element can be displaced by the electrode element, but then exerts the clamping force on the electrode element, since it wants to return to its original position again.

The electrode stacking wheel, the stacking fingers, and in particular the electrode clamping elements are preferably also formed from one piece.

The main surface of the electrode element is in particular designed as a surface with a larger surface area than the side surfaces. In particular, the main surface is the surface which, in the clamping state, is formed in the direction of the stacking fingers, in other words in particular not an end face or side surface, which is narrower by a multiple than the main surface.

Each of the intermediate spaces is preferably open in the axial direction.

In particular, the stacking fingers have a curvature. The curvature in particular runs counter to the running direction of the electrode stacking wheel.

However, the stacking fingers and/or the intermediate spaces can also be designed without a curvature, in particular for receiving electrode elements with limited flexibility or rigid electrode elements. The position in the electrode stacking wheel can then be radial or secant.

In particular, a plurality of electrode elements are conveyed to the electrode stacking wheel in order to produce the electrode stack. The electrode elements can be designed as a cathode and/or anode. In particular, cathodes and anodes are conveyed alternately. A separator or a separating layer is in particular arranged between the electrode elements, in particular between the cathode and the anode.

Alternatively, the electrode elements can also be formed as a prefabricated cell comprising a cathode, an anode, and preferably also at least one separating layer. The electrode element can already be formed as a cell and finished cells can be stacked on top of one another by the electrode stacking wheel.

It is preferably provided that the electrode clamping element is, in particular, elastic and spring-loaded, and a spring force can be applied to the electrode element by the electrode clamping element. In particular, the spring-loaded property is made possible by the material and the material thickness of the electrode clamping element. Due to the spring-loaded design, the clamping force can be provided passively, in other words without external energy. An electric actuator can be dispensed with in this case. The electrode clamping element can rest against the adjacent stacking finger in the non-clamped state and is only moved or pushed away from it by the electrode element inserted into the intermediate space.

Additionally or alternatively, the electrode clamping element can provide the clamping force actively, in particular by means of an actuator which is preferably electric.

Furthermore, it is preferably provided that the electrode clamping element is designed as part of the respective stacking finger. The electrode clamping element can therefore be designed, for example, as a branch or branching of the stacking finger. The electrode clamping element is preferably narrower or thinner than the respective stacking finger. The electrode clamping element can therefore be produced such that, for example, a half-slot is introduced into the stacking finger. The electrode clamping element is partially separated from the stacking finger by the half-slot. However, due to the partial separation, the electrode clamping element is preferably still connected to the stacking finger at a contact point and can be formed thereon in a spring-loaded manner.

Furthermore, it is preferably provided that the electrode clamping element is connected to the respective stacking finger by means of a contact point. The surface area of the contact point is preferably only so large that the electrode clamping element can be formed flexibly on the stacking finger. The contact point provides a means for the electrode clamping element to reliably provide the clamping force.

Furthermore, it is preferably provided that the electrode clamping element is made from the same material as the stacking finger. The material is designed as a plastic, for example. As a result, the electrode clamping element can be designed to be cost-effective and reliable.

The invention also relates to an electrode stacking device, in particular for producing an electrode stack for a rechargeable battery or a fuel cell. The electrode stacking device has at least one electrode stacking wheel according to the invention.

In particular, the electrode stacking device has a plurality of electrode stacking wheels according to the invention.

It is preferably provided that the electrode stacking device has, axially offset from the electrode stacking wheel, at least one clamping element-free stacking wheel having the same spindle. By combining electrode stacking wheels with electrode clamping elements and stacking wheels without electrode clamping elements, the transporting accuracy of the electrode elements can be further increased. It may be that only a few electrode stacking wheels with electrode clamping elements, for example one or two, are sufficient to clamp the respective electrode element during transport. Too high a number of electrode clamping elements can have the disadvantage that the insertion of the electrode element into the intermediate space is made unnecessarily more difficult, as the resistance of all electrode clamping elements which occurs as they are inserted has to be overcome.

The invention relates to a further aspect of an electrode stacking device with a plurality of stacking wheels or electrode stacking wheels arranged on a common spindle. According to the further aspect, the stacking wheels or electrode stacking wheels can, additionally or alternatively to being fitted with the electrode clamping element, be arranged such that they are rotated with respect to the spindle, in other words they can be rotated by the rotation in the direction of rotation such that the intermediate spaces no longer align exactly in the axial direction, but are only aligned obliquely to the axial direction. This is advantageous, as the electrode elements are clamped by the stacking wheels rotated relative to one another. The rotated stacking wheels can be formed in addition to the electrode clamping elements, or alternatively without the electrode clamping elements.

The invention also relates to a method. In the method according to the invention, an electrode stack, in particular for a rechargeable battery or a fuel cell, is produced with planar electrode elements. The following steps are performed:
a) providing an electrode element;
b) rotating an electrode stacking wheel about a spindle;
c) introducing the provided electrode element into an intermediate space formed by stacking fingers of the electrode stacking wheel;
d) moving the electrode element thus introduced through the electrode stacking wheel rotating about the spindle;
e) removing the moving electrode element from the intermediate space; and
f) producing the electrode stack with the electrode element removed from the intermediate space.

As the key idea, it is provided that a clamping force is applied to the electrode element, during its movement through the electrode stacking wheel, in a clamping position by means of an electrode clamping element.

In particular, the electrode element is in the clamping position when it is fixed by the electrode clamping element.

It is preferably provided that a passive stripping element which overcomes the clamping force is used to remove the electrode element from the intermediate space in step e). The passive stripping element can be formed, for example, from a stripping arm, against which the electrode elements are enmeshed by the electrode stacking wheel once the transport path has been completed and automatically stripped by the ongoing rotation of the electrode stacking wheel.

Furthermore, it is preferably provided that an active stripping element which overcomes the clamping force is used to remove the electrode element from the intermediate space in step e). The active stripping element can be designed, for example, as a cam wheel. The cam wheel can, for example, run along the electrode elements and actively strip them once the transport path has been completed. The active stripping element can be driven by the drive of the electrode stacking wheel or a separate drive, in particular a dedicated drive.

Furthermore, it is preferably provided that the electrode element is braked by the electrode clamping element in step c). Due to the braking effect of the electrode clamping element, the electrode element can be arranged and transported more accurately in the intermediate space. As a result of the more accurate arrangement in the electrode stacking wheel, the electrode element can also be deposited more accurately on the electrode stack.

Furthermore, it is preferably provided that the electrode element is conveyed into the clamping position in a controlled manner by a feeding device in step a). In this context, “in a controlled manner” means that the movement of the electrode element is not left to chance, as is the case, for example, with unguided or free flight through the air. In the case of controlled conveying, the position of the electrode element can substantially be influenced at any time. Controlled conveying exists, for example, when the electrode element is clamped by means of a belt. In the present case, the electrode element is preferably transported by a belt, in a controlled manner, directly into the electrode stacking wheel or the respective intermediate space, and clamped there by the electrode clamping elements. The belt guiding is preferably terminated by the feeding device at the earliest following the clamping by the electrode clamping elements.

Furthermore, it is preferably provided that, from the time at which the electrode element is located in the clamping position, the control over the electrode element passes from the feeding device to the electrode stacking wheel. The electrode element is therefore preferably pushed from the feeding device into the intermediate space until the electrode element is in the clamped state, then the feeding device ends the movement and the control of the electrode element. The movement and the control of the electrode element are subsequently assumed or continued in a substantially seamless manner by the electrode stacking wheel. The electrode stack can thus be produced more accurately.

Furthermore, it is preferably provided that the electrode element is introduced into the intermediate space by a feed wheel, in particular the feeding device, with a raised contact attachment that extends circumferentially around only part of the feed wheel. In this case, the contact attachment is designed in particular as a raised segment that is only partially circumferential. The contact attachment can be used to bring the respective electrode element more accurately into the clamping position, as the start and end of the control by the feed wheel or the feeding device can be determined more accurately.

The electrode element can have a cell arrester. The cell arrester is used for electrically conductive contacting of the respective electrode element.

The preferred embodiments presented with reference to the electrode stacking wheel according to the invention and the advantages thereof apply accordingly to the stacking device according to the invention and the method according to the invention, and vice versa.

Further features of the invention are apparent from the claims, the figures, and the description of the figures.

Exemplary embodiments of the invention are explained in more detail below by means of a schematic drawing.

In the drawings:

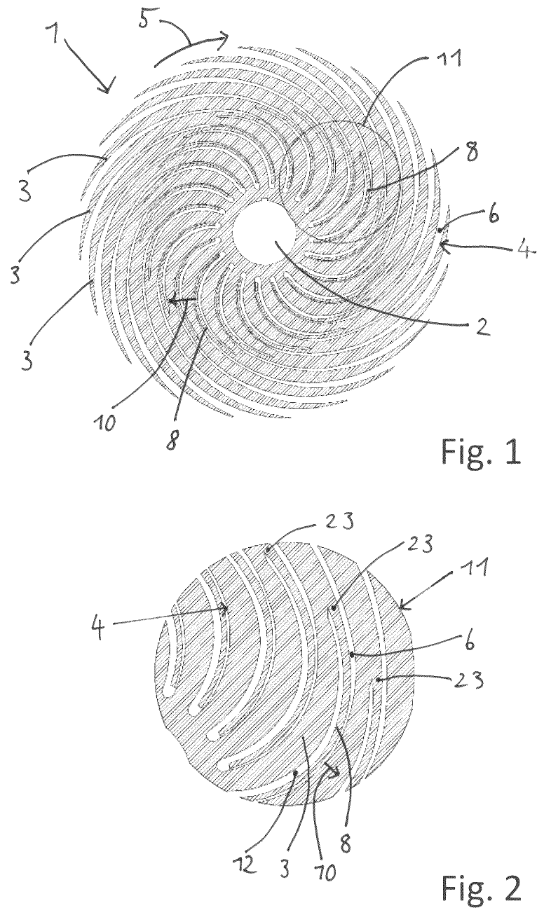

FIG. 1 shows a side view of a schematic representation of an exemplary embodiment of an electrode stacking wheel according to the invention with electrode clamping elements;

FIG. 2 shows a schematic detailed view of the electrode clamping elements;

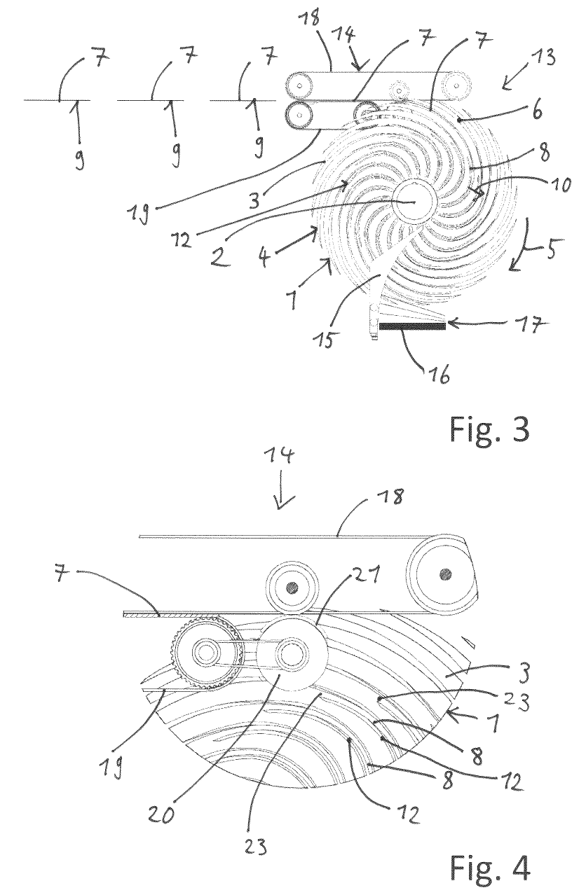

FIG. 3 is a schematic representation of an exemplary embodiment of an electrode stacking device according to the invention with the electrode stacking wheel and a feeding device;

FIG. 4 shows a schematic detailed view of the feeding device; and

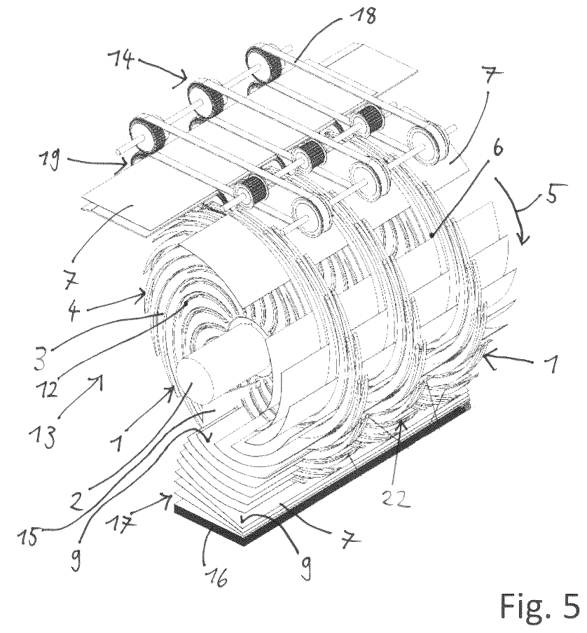

FIG. 5 is a schematic representation of a further exemplary embodiment of the electrode stacking device with a plurality of electrode stacking wheels and clamping element-free stacking wheels.

In the figures, identical or functionally identical elements have been given the same reference numbers.

FIG. 1 schematically shows an exemplary embodiment of an electrode stacking wheel 1 with a spindle 2.

Stacking fingers 3 are arranged circumferentially around the spindle 2. The stacking fingers 3 are in particular arranged radially to the spindle 2, in other words the stacking fingers 3 are arranged such that they protrude from the spindle 2.

Furthermore, the stacking fingers 3 have a curvature 4 according to the exemplary embodiment. The curvature 4 runs counter to a running direction or direction of rotation 5 of the electrode stacking wheel 1. The stacking fingers 3 are thus formed so as to be curved, in particular in a counterclockwise direction.

Furthermore, the thickness of the respective stacking finger 3 substantially tapers as the distance from the spindle 2 increases.

A pocket-shaped intermediate space 6 is formed between the stacking fingers 3. The intermediate space 6 is designed to receive a planar electrode element 7 (shown in FIGS. 3 to 5). The intermediate space 6 is preferably open in both axial directions.

The electrode stacking wheel 1 rotates about the spindle 2. In particular, the electrode stacking wheel 1 rotates clockwise when viewed in the image plane shown in FIG. 1. The rotational speed is preferably at least 20 revolutions per minute. Furthermore, the rotational speed can be, for example, up to a maximum of 60 revolutions per minute. In particular, the rotational speed is dependent on the number of intermediate spaces in relation to the transport speed of the electrode elements.

An electrode clamping element 8 is formed in each of the intermediate spaces 6.

In the clamping state, a clamping force is applied to a main surface 9 (shown in FIG. 5) of the electrode element 7 by the electrode clamping element 8.

The clamping force has a direction of action 10 which acts in the clamping state in the direction of an adjacent stacking finger or an inserted electrode element 7.

The electrode clamping element 8 is preferably made from the same material as the stacking finger 3, in particular from plastic.

FIG. 1 shows a detail 11 of the electrode stacking wheel 1, which is described in more detail in FIG. 2.

FIG. 2 shows the detail 11 of the electrode stacking wheel 1. According to the exemplary embodiment, the electrode clamping element 8 is designed as part of the stacking finger 3. The electrode clamping element 8 is only partially separated from the stacking finger 3 by a half-slot 12.

The electrode clamping element 8 is connected to the stacking finger 3 at a contact point 23.

In particular, the electrode clamping element 8 is designed to be flexible to such an extent that it can have a spring effect or provide a spring force. In the clamping state, the spring force is exerted on the electrode element 7.

FIG. 3 schematically shows an electrode stacking device 13 with the electrode stacking wheel 1 and a feeding device 14.

According to the exemplary embodiment, the electrode stacking device 13 is designed with a plurality of electrode stacking wheels 1. The electrode stacking wheels 1 are arranged on the common spindle 2.

Furthermore, the electrode stacking device 13 has a stripping element 15 and a stacking base 16. An electrode stack 17 is formed on the stacking base 16.

The following is an example of a stacking process: Electrode elements 7 are fed to the electrode stacking wheel 1 or the electrode stacking wheels 1 by means of the feeding device 14. Received in the respective intermediate space 6 and clamped by the associated electrode clamping element 8. The electrode element 7 is then transported by means of the electrode stacking wheels 1 as a result of the active electrode stacking wheels 1 rotating. The stripping element 15 then removes the electrode element 7 from the intermediate space 6, wherein it is deposited on the stacking base 16 or on top of electrode elements 8 already sitting on the stacking base 16.

According to the exemplary embodiment, the stripping element 15 is designed to be passive. However, it can also be designed as an active stripping element, for example as a cam wheel that is driven by an electric drive unit.

In particular, the respective electrode element 7 is controlled without interruption by either the feeding device 14 or the electrode stacking wheels 1.

According to the exemplary embodiment, the feeding device 14 has an upper belt 18 and a lower belt 19. The belts 18, 19 are moved in such a way that the respective electrode elements 7 are transported to the electrode stacking wheel 1.

The lower belt is preferably shorter than the upper belt. As a result, the respective electrode element 7 can be introduced or inserted into the electrode stacking wheel 1 in a controlled manner.

FIG. 4 shows a schematic detailed view of the feeding device 14.

The feeding device 14 has a feed wheel 20. The feed wheel 20 pushes the respective electrode element 7 into the intermediate space 6 until a clamping force is applied by the electrode clamping element 8, thus fixing the electrode element in place.

According to the exemplary embodiment, the feed wheel 20 has a contact attachment 21. The contact attachment 21 is raised and extends circumferentially around only part, in particular less than 180°, of the feed wheel 20. In particular, only the contact attachment 21 makes contact with the respective electrode element 7, in particular the main surface 9. If the feed wheel 20 is oriented such that the contact attachment 21 is not pointing in the direction of the upper belt 18, the electrode element 7 is no longer pushed by the feed wheel 20. The contact attachment 21 is therefore advantageous for interrupting the action of the feed force from the feed wheel 20 on the respective electrode element 7.

In particular, it is preferably provided that the clamping of the electrode element 7 between the contact attachment 21 and the upper belt 18 or a counter wheel of the upper belt 18 is only able to begin once the electrode element 7 is already partially inside the intermediate space 6. Furthermore, the clamping between the contact attachment 21 and the upper belt 18 is preferably ended before the electrode element 7 is fully inside the intermediate space 6.

The feed wheel 20 rotates further in the clockwise direction, as seen in the image plane shown in FIG. 4, until the contact attachment 21 is again aligned with respect to the upper belt 18. Then one of the electrode elements 7 can be contacted and moved again.

The feed wheel 20 can be coupled to the drive of the lower belt 19, or alternatively it can be driven with a separate drive.

FIG. 5 schematically shows an exemplary embodiment of the electrode stacking device 13.

Two electrode stacking wheels 1 are each arranged with electrode clamping elements 8 on the spindle 2. A clamping element-free stacking wheel 22 is arranged on the spindle 2 between the two electrode stacking wheels 1. The clamping element-free stacking wheel 22 has no electrode clamping elements 8 but otherwise is designed in particular analogously to the electrode stacking wheel 1. Combining the electrode stacking wheels 1 with the clamping element-free stacking wheel 22 allows the electrode elements 7 to be clamped in place, but still easily inserted into the intermediate spaces 6.

Additionally or alternatively, the electrode stacking wheels 1 and/or the stacking wheel 22 can be arranged on the spindle 2 such that they are slightly rotated, with the result that the intermediate spaces 6 of the respective wheels 1, 22 are not exactly aligned in the axial direction. As a result, the electrode elements 7 can also be fixed in position. The rotated stacking wheels can be an alternative or addition to the electrode clamping elements 8.

1.-14. (canceled)

15. An electrode stacking wheel designed to receive and convey planar electrode elements, the electrode-stacking wheel comprising:
a spindle designed to rotate the electrode stacking wheel;
a plurality of stacking fingers, which are radial to the spindle and which are arranged circumferentially around the spindle; and
a plurality of intermediate spaces, each of which is formed between the stacking fingers, wherein a respective intermediate space is designed to receive at least one of the electrode elements;
wherein
an electrode clamping element formed in each of the intermediate spaces,
wherein the electrode clamping element is designed, in the clamping state, to apply clamping force to a main surface of one of the electrode elements and to press the respective electrode element against the respective stacking finger by means of the application of force.

16. The electrode stacking wheel according to claim 15, wherein the electrode clamping element is spring-loaded, and a spring force can be applied to the electrode element by the electrode clamping element.

17. The electrode stacking wheel according to claim 15, wherein
the electrode clamping element is designed as part of the respective stacking finger.

18. The electrode stacking wheel according to claim 15, wherein the electrode clamping element is connected to the respective stacking finger by a contact point.

19. The electrode stacking wheel according to claim 15, wherein the electrode clamping element is made from the same material as the stacking finger.

20. An electrode stacking device comprising at least one electrode stacking wheel according to claim 15.

21. The electrode stacking device according to claim 20, wherein the electrode stacking device has, axially offset from the electrode stacking wheel, at least one clamping element-free stacking wheel having the same spindle.

22. A method for producing an electrode stack with planar electrode elements, in which the following steps are performed:
a) providing an electrode element;
b) rotating an electrode stacking wheel about a spindle;
c) introducing the provided electrode element into an intermediate space formed by stacking fingers of the electrode stacking wheel;
d) moving the electrode element thus introduced through the electrode stacking wheel rotating about the spindle;
e) removing the moving electrode element from the intermediate space; and
f) producing the electrode stack with the electrode element removed from the intermediate space,
wherein
a clamping force is applied to the electrode element, during its movement through the electrode stacking wheel, in a clamping position by means of an electrode clamping element.

23. The method according to claim 22, wherein a passive stripping element which overcomes the clamping force is used to remove the electrode element from the intermediate space in step e).

24. The method according to claim 22, wherein an active stripping element which overcomes the clamping force is used to remove the electrode element from the intermediate space in step e).

25. The method according to claim 22, wherein the electrode element is braked by the electrode clamping element in step c).

26. The method according to claim 22, wherein the electrode element is conveyed into the clamping position in a controlled manner by a feeding device in step a).

27. The method according to claim 26, wherein from the time at which the electrode element is located in the clamping position, the control over the electrode element passes from the feeding device to the electrode stacking wheel.

28. The method according to claim 26, wherein the electrode element is introduced into the intermediate space by a feed wheel with a raised contact attachment that extends circumferentially around only part of the feed wheel.
